(19) United States
(12) Patent Application Publication
(10) Pub. No.: US 2016/0233722 A1
(43) Pub. Date: Aug. 11, 2016

(54) Backup Power System to Sump Pump

(71) Applicant: Yiping Zhou, Orland Park, IL (US)

(72) Inventor: Yiping Zhou, Orland Park, IL (US)

(21) Appl. No.: 14/616,723

(22) Filed: Feb. 8, 2015

(51) Int. Cl. H02J 9/06; H02J 7/00; F04D 13/08

(52) U.S. Cl. CPC H02J 9/062; F04D 13/08; H02J 7/0068

(57) ABSTRACT

A backup power system provides uninterrupted AC power to single sump pump to protect basement from flooding during normal power supply period and power outage period.

### TECHNICAL FIELD AND RESIDENTIAL APPLICABILITY OF THE INVENTION

This invention relates to provide backup power to residential sump pumps with inverter and charger combo-unit. Normal AC power and backup AC power provide uninterrupted power to single sump pump to protect basement from flooding during power outage.

### BACKGROUND OF THE INVENTION

Sump pumps are used in basement of industrial buildings or residential homes, where basement floor elevation is below the groundwater elevation. Sump pumps maintain groundwater level to desired elevation so that the basement is protected from flooding. The Sump pumps are critical during storm events when the groundwater level can increase significantly. Sump pumps in most of residential home are connected to regular home power supply (either 110V AC in USA or 220V AC in some countries). During storm events, power outages often occur, especially, when power lines are damaged by strong wind. However, this is the time when sump pumps are needed the most to lower groundwater level and to protect basement from flooding. Every year there are many homes ate flooded by combined effects of raising groundwater and power outages during storm events. Basement flooding is nightmare for most homeowners. Therefore, backup sump pumps, powered by battery, with relatively low cost are used to pump groundwater during power outages.

All commercial available backup sump pump systems for home application use a battery powered standby DC pump. One will need place two sump pumps (one regular AC sump pump and one standby DC pump) in the sump pit. Such system has the following problems: 1. Piping for two sump pumps is very congested in most sump pits; 2. Standby DC pump, powered by 12V DC typically does not have sufficient capacity to remove excessive groundwater in order to prevent flooding during heavy storm events.

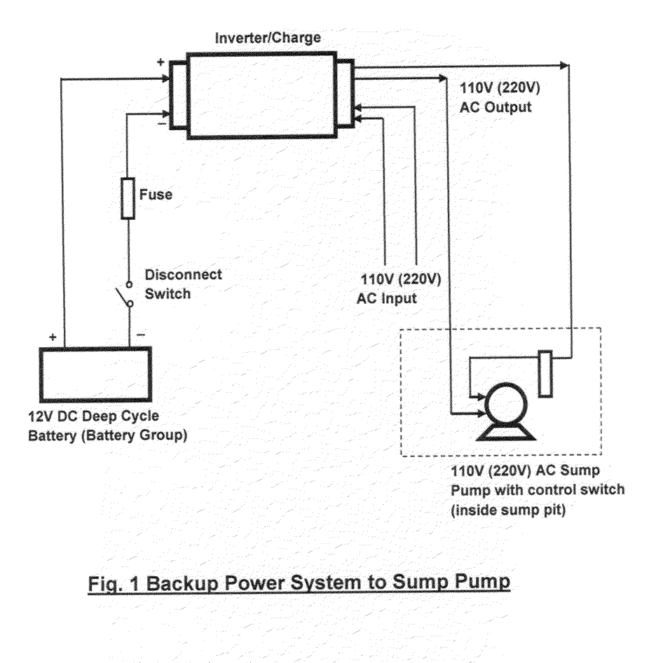

FIG. 1 shows the following 1. Under normal AC power supply, the Inverter/Charge will switch power supply of AC input (110V or 220V) automatically to sump pump; 2. The battery is maintained to be fully charged. 3. If normal AC power is off (power outage condition), the Inverter/Charge will automatically switch power supply to the 12 V DC Deep Cycle Battery, invert 12 V DC to 110 V AC (or 220 V AC) end supply inverted AC power to the sump pump.

What is the claimed is:

1. A backup power supply system comprising: deep cycle 12V DC battery or battery group, manual disconnect switch, cable, fuse, and inverter/charger combo unit.

2. The backup power supply system of claim 1 provides the same voltage AC during power outages to the regular sump pump.

3. The backup power supply system in claim 2 eliminates the need of backup DC sump pump in the sump pit.

4. The backup power supply system in claim 2 maintains the capacity of sump pump during power outage period.

5. When AC power is available, the backup power supply in claim 1 recharges the battery (or battery group) and allows surplus AC power to pass through and to power the sump pump.

6. When the AC power is disconnected (power outage), the backup power supply system inverts DC battery power to AC electricity and provides uninterrupted power to the sump pump.

7. The backup power supply in claim 1 has over-current protect with fuse for battery power supply.
